(19) United States
(12) Patent Application Publication
(10) Pub. No.: US 2002/0036094 A1
(43) Pub. Date: Mar. 28, 2002

(54) Secure cage for telecommunications fiber optic cable assembled splices

(76) Inventor: Michael A. DeNatale, Arnold, MO (US)

Correspondence Address: PAUL M. DENK, 763 South New Ballas Road, St Louis, MO, 63141, US

(21) Appl. No.: 09/900,096

(22) Filed: Jul. 5, 2001

Related U.S. Application Data
(60) Provisional application No. 60/216,449, filed on Jul. 6, 2000.

(51) Int. Cl. H01B 7/06

(52) U.S. Cl. 174/69

(57) ABSTRACT

A secure cage for use in a manhole for surrounding a splice box in which fiber optic or other cable is spliced together in the development of a telecommunication system for business users. The secure cage includes approximately four panels, hinged together, which may be collapsed to facilitate its locating and storage, and which may be erected, down in the manhole, to enclose each splice box and its spliced cables, segregating the telecommunications for each business user from each other.

### CROSS-REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

This invention relates to underground telecommunications systems, and more specifically, provides a collapsible enclosure for use for enveloping select group of splicing of such fiber optic cables down in their located manhole. This invention relates to the business of developing and building telecommunications infrastructure, generally for use in and around the cities of the Country. This invention is primarily for use in combination with the construction of underground telecommunication manhole systems, in the streets of the cities, and to provide protection for the splicing of their various cables, when assembled for usage. Generally, such manhole systems interconnect a wide array of systems together, incorporating multiple duct work systems generally formed of a standard twelve 1½ inch diameter high density polyethylene pipe, which are normally called inner duct, or ducts, arranged between the manhole systems. Once these are fabricated and installed, a grouping of various ducts are then sold or leased to competing telecommunications companies, in order for these installers to assemble and install the fiber optic cables, used in their telecommunications networks. Usually, these types of cables provide high capacity service to large business users.

Generally, such systems are built for a two to three mile network, and incorporate and have emplaced underground concrete structures called manholes, usually in strategic locations within a city. These particular manholes are designed for telecommunications projects, and are usually assembled to be of a square or of rectangular concrete shape, and can even be fabricated above ground, and then placed underground and covered over, once used. The manhole, in effect, becomes a room with a round metal lid, just like a manhole cover, at grade level, which is capable of being pulled off to gain access into the manhole, for either installation or assembly of the cables, or for their maintenance. These manholes are placed in strategic locations to facilitate the pulling and storage of the telecommunications facilities, such as the fiber optic cable, coaxial cable, or copper cable, once these systems are installed for usage.

Normally, when these systems are installed within a city, because of both capacity purposes, and further because of code, and other regulations, there is only a limited amount of space within or under the streets, to accommodate such duct work, and manholes. Rather than provide each grouping of three ducts with a separate manhole, as to accommodate three separate business customers, the installers are required to provide at least one large manhole, with cover, and the space within the manhole must be shared by a minimum of four customers, to save space. The issue of space separation and security, in these manholes, and typically a city may have as many as thirty such manholes, does become a problem. Thus, the reason for this current invention is to provide dome degree of security, separation, and confidentiality, with respect to the fiber optic cables and the telecommunication system that may be installed for a particular business user, by a telecommunications installer, and maintain some degree of separation from the other systems of other competitors, and other users, underground, within the same installed manhole.

### SUMMARY OF THE INVENTION

The principal of the current invention is to provide for a manhole of a standard size, and into which at least four systems for telecommunications networks may be installed, and have their various cables spliced separately together, to accommodate and provide communications services to the various large business users. In the construction of these systems, by the applicant herein, it has been found that a manhole sized to have dimensions in the range of 12 feet long, 6 feet wide, and 7 feet high, more or less, is a very satisfactory design, and which can uniquely accommodate at least four business users, all of their cables for their system, and their various splicing as required to provide for communications transmission generally over their installed fiber optic cables. Basically, this invention includes the usage, application, installation of a lightweight folding cage, generally named as a “secure cage,” down in the manhole, to enclose and shield one group of spliced fiber optic cables, from the other three or more systems that may be located within the same manhole. The need for such a cage is to provide a device which can furnish protection for a company's slack coil of telecom cable, and the splice and which cage may be left within the manhole, in order to provide the benefits as previously reviewed.

Furthermore, splicing of fiber optic cable needs to take place in a controlled environment, which does not include a manhole. This requires placing enough slack fiber optic cable in the manhole, which can be taken in through the opening, or lid, to the street above. There, an environmentally controlled trailer or vehicle is used for the splicing process. Once completed, the slack coil is then placed into the manhole, generally in that configuration of coiling in order to take up any slack cable, and is located within the splice case, for that particular business customer. But, the splicing, the cables, and all other paraphernalia used in such system, is readily exposed, which may be undesirable to a business that maintains extreme confidentiality, in its operations, but yet has very lack security as a result of the exposure of its various cables simply within a manhole underground, at a remote location.

Thus, the subject of this invention is to provide for a screen-like enclosure that may be folded, and located around the splicing segment of the fiber optic cables for a particular customer, in order to add security, and some degree of privacy and confidentiality, for that system.

Another object of this invention is to provide for a metallic or other material screen-like member that is foldable, to provide for a condensed size, when inserted through a manhole cover and down into the underground manhole, in preparation for its unfolding and arrangement for covering the splice and splice box for a fiber optic telecommunications system.

Another object of this invention is to provide such a protective screen that may be fabricated of metal, or polymer, or the like, in order to resist deterioration.

These and other objects may become more apparent to those skilled in the art upon review of the summary provided herein, and upon undertaking a study of the description of its preferred embodiment, further in view of the drawings.

### BRIEF DESCRIPTION OF THE DRAWINGS

In referring to the drawings, FIG. 1 provides a perspective view of the secure cage of this invention, fully erected as during usage and application;

FIG. 2 provides a plan view of a manhole, with four splicing stations for telecommunications cable being provided therein;

FIG. 3 is a side view of the manhole shown in FIG. 2;

FIG. 4 is a plan view showing the manhole with the location of the splice systems;

FIG. 5 is a side view of the manhole of FIG. 4, and showing the arrangement of the fiber optic or other cables entering into the manhole and assembled within their separate splice boxes;

FIG. 6 is an end view of a manhole, such as shown in FIG. 5; and

FIG. 7 is a perspective view of the secure cage of this invention partially folded into its collapsed position.

### DESCRIPTION OF THE PREFERRED EMBODIMENT

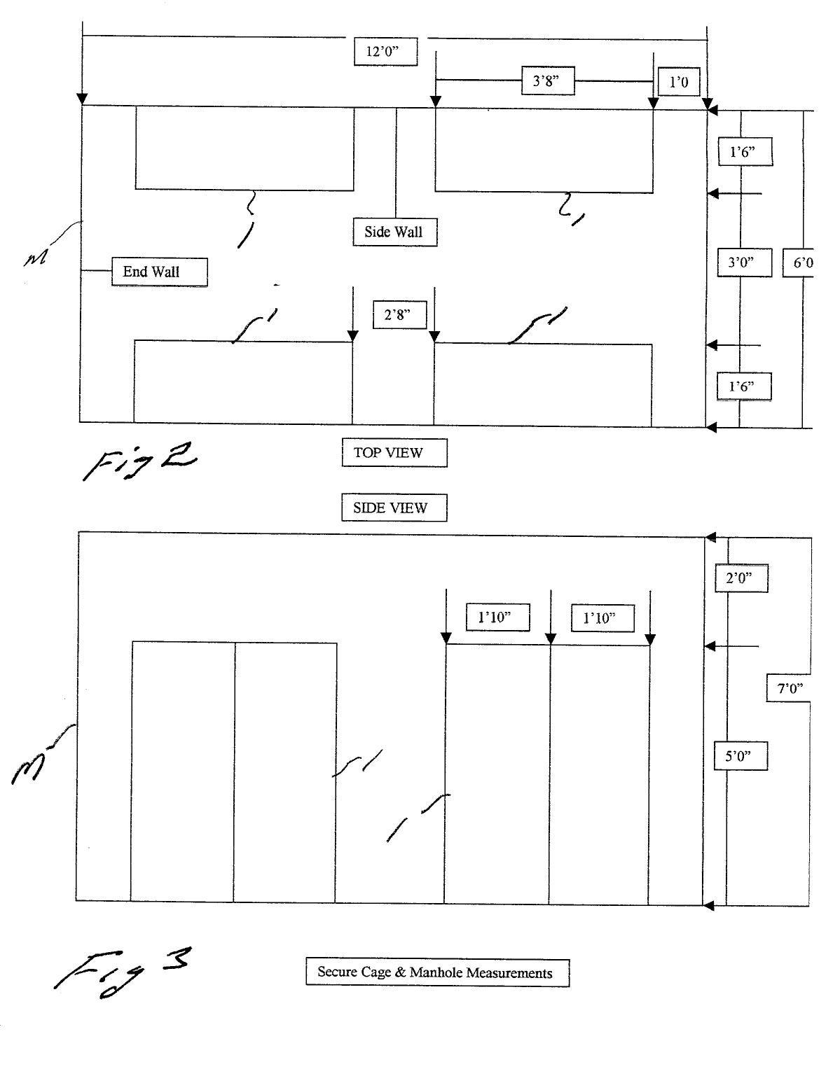

In referring to FIG. 1, the secure cage 1 of this invention is readily disclosed, and is generally formed of a lightweight gauge material, such as aluminum, perhaps even a polymer, is rust resistant, with a gauge generally being in the preferred embodiment somewhere in the range of 18 to 20. If formed of metal, or even plastic, it may be perforated or have a series of holes punched in it, in order to provide some degree of ventilation, but at the same time, provide for a lighter weight through its structure, without diminishing its strength. Generally, as can be seen, the cage is formed of a series of a screens, approximately four in number, more or less, with a pair of collapsible front screens 2 and 3, and side screens 4 and 5 as noted. These various screens are connected together along their length by a series of pivot means, such as hinges, or by piano hinges 6 through 8, as noted. As can be seen in FIG. 1, the structure of the cage is such that it can be arranged in an upright and erect position, when unfolded, with a pair of side panels, and can be located around the splice boxes SB, down in the manhole, in order to provide the type of security and sheltering as previously explained. See FIG. 4.

The secured cage is also shown in FIG. 7 and a partially folded or collapsed position, such as when it is either being reduced in size, for the purpose of allowing it to be located down through the manhole cover, and into the structure of the manhole, for erection and assembly, as noted in FIG. 4. Or, FIG. 7 shows the cage as it is being opened, and erected, down in the manhole, to provide for the type of coverage, as previously explained.

Provided upon each side edge of the side walls 4 and 5 are hasp devices, as at 9 and 10, and which are furnished to allow for the secured cage to be connected to built-in fasteners, in the side wall of the manhole, to secure the cage in place, and generally prevent its unauthorized removal, further adding to the security of the splice box. Any lock means may also be used for this purpose.

In the preferred embodiment, the four sections for the secure cage generally will have a size that allows for its facile handling, that may be easily folded, with each segment having a width of approximately 24 inches, 5 feet in length, and approximately 3 inches thick, more or less. These dimensions generally describe the overall configuration for each panel, of the cage, comprising those panels 2 through 5, as noted. Thus, when the cage is folded into closure, it will afford its locating and emplacement into the manhole, through its standard 30 inch lid opening.

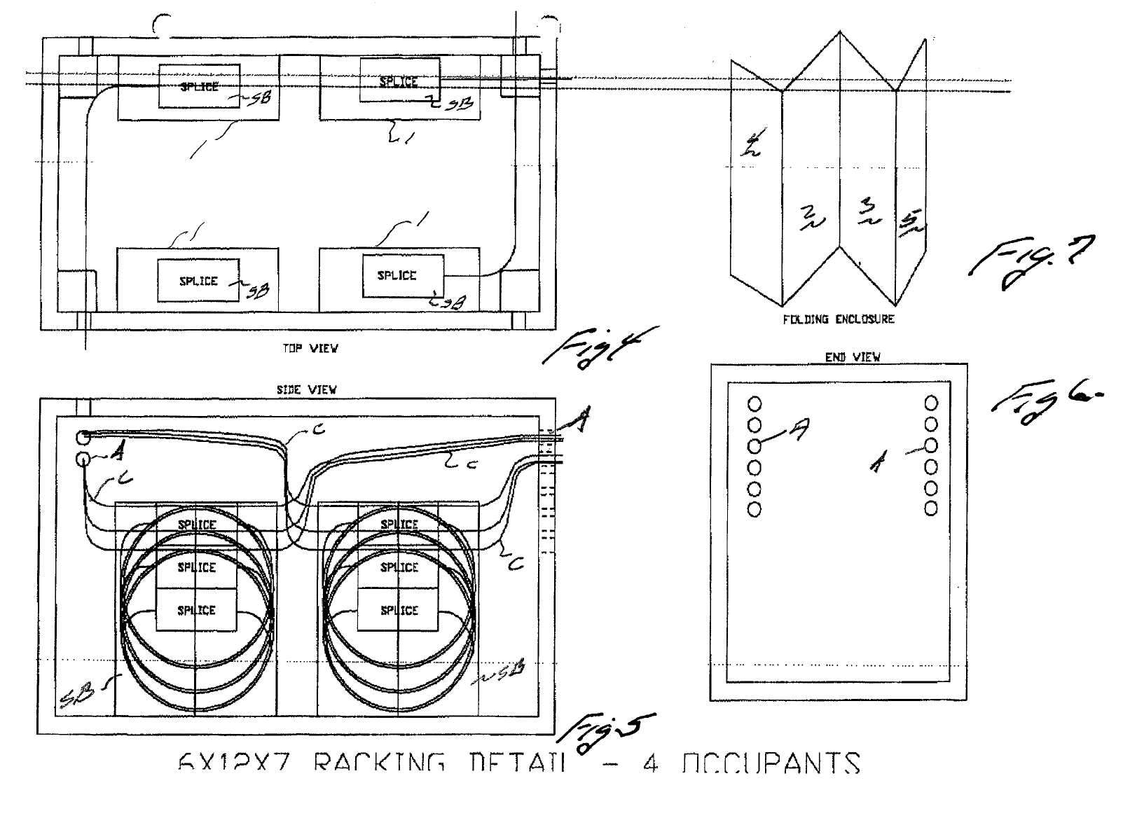

The general purpose of the secure cage 1, as previously explained, is to separate the space in the manholes into four distinct areas, as can be noted in FIG. 4. These areas generally define four splice boxes, as at SB, as also noted in FIG. 5. As previously explained, the fiber optic cable C enters into the manhole, through the various apertures A, as noted in FIGS. 5 and 6. Each area, formed by the secure cage, will be approximately 44 inches wide, and 15 to 18 inches deep, more or less, compensating for the thickness of the materials that form the various panels for the cage. Thus, this provides ample room for storage of any slack coil, of the multiple fiber optic cables that are spliced together, and to mount the same into the splice case, on an existing racking, within the manhole, as already exists. As stated, the secure cage will be approximately 5 feet tall, leaving a 2 foot clearance above it, for attaching and routing of cable through the manhole, out its various apertures A, for their locating towards the business establishment, that it services.

By providing the variety of hasps in hinges, the customer is capable of firmly attaching one side of the cage with a nonremovable fastener, or even a lock, while connecting the other side with a removable device, such as a padlock. Access to the cable is gained by removing the lock and folding the secure cage to an end wall, to allow clearance and access to the splice box, as required. Once the work by the serviceman is completed, and the cable is returned, the secure cage is unfolded and placed back into its erected position, and secured in place. Obviously, a secure cage of this type is not designed to protect against extreme vandalism, but it does offer a reasonable amount of dedicated space and security from accidental removal or tampering of the fiber optic cable that is spliced therein, once installed.

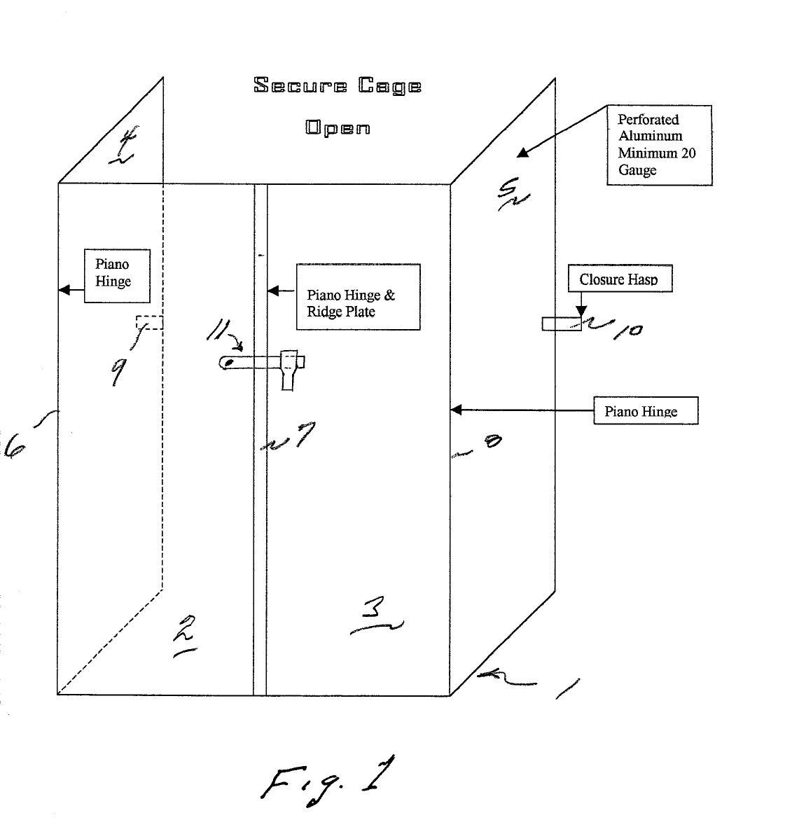

FIG. 2 provides a view of the manhole M, with the four secure cages 1 being located in position. FIG. 3 provides a side view of the configured manhole, with secure cages 1 arranged therein, in an elevation view.

As can further be seen in FIG. 1, a pivotal latch 11 is provided between the two front panels 2 and 3, so that when they are unfolded into an erect position, the latch may be pivoted into place, to provide for the retention of the two front panels into alignment, when forming the cage structure.

Variations or modifications to the subject matter of this invention may occur to those skilled in the art upon reviewing the disclosure as provided herein. Such variations, if within the spirit of this development, is intended to be encompassed within the scope of the invention as described herein. The description of the preferred embodiment, in view of its drawings, is set forth for illustrative purposes only.

1. A secure cage for a cable securing structure, for providing a dedicated space for locating of specific cables for use for signal transmission in the telecommunications field, said cage being formed of a series of panels, capable of being erected into its space providing structure, or folded and collapsed as during non-use for providing direct access to the cables for servicing, a series of foldable panels, said panels being folded into an erected polygonal shape to provide security for any cables located therein, said panels for the cage forming a pair of side panels, and front panels, the side panels capable of securing to the approximate structure, the front panels capable of being locked into a protective configuration, said front panels capable of being opened, and in conjunction with the side panels, being folded back to provide access to any cables maintained therein during servicing.

2. The secure cage of claim 1 wherein said cage locates within a manhole structure of the type provided for accommodating a plurality of fiber optic cables, the side panels of the cage being permanently secured to a side of the manhole structure, and the front panels capable of being locked into position for providing security and protection for any cables therein, but further capable of being opened to provide access to the cables for servicing.

3. The secure cage of claim 1 wherein said cage being provided within a manhole structure, one of said sidewalls being permanently affixed to a side of the manhole structure, and the other side panel being normally fastened and locked to the side of the manhole structure, but capable of being opened, to provide for folding of the various cage panels into a non-usable position to provide access to the cables during servicing.

4. The secure cage of claims 2 or 3 and wherein said panels include a series of perforations to provide ventilation to the cables disposed therein.

5. The secure cage of claim 4 wherein said secure cage is provided for protecting the spliced dedicated cables for an individual customer.

6. The secure cage of claim 5 wherein the front panel includes a pair of front panels, said front panels having sides, said front panels, along one side, being hinged together, and said front panels at their other sides being hinged to the side panels for the said cage, whereby all of said panels may be folded into a collapsed and substantially flattened condition when the cage is opened during servicing of the cables, but can be erected and locked into closure to provide protection and securement for any cables installed therein.

7. The secure cage of claim 6 wherein its panels are formed of a lightweight material.

8. The secure cage of claim 7 wherein the panels are formed of aluminum.

9. The secure cage of claim 7 wherein said panels are formed of a rigid polymer.

10. The secure cage of claim 7 wherein each secure cage has a dimension of approximately four feet wide, and one to two feet deep, and five feet in height.

11. The secure cage of claim 10 wherein each panel of the secure cage is approximately five feet in height, and 18 to 24 inches in width.

12. The secure cage of claim 1, wherein that edge of each side panel that secures to a side of the manhole structure includes an angle, and each angle capable of fastening to the side of the manhole.

13. The secure cage of claim 2, wherein one edge of one side panel, including an angle, and capable of being rigidly fastened to a side of the manhole, while an edge of the opposite side panel capable of being removably locked to the side of the manhole structure during installation and erection of the secure cage.
